(19) United States
(12) Patent Application Publication
(10) Pub. No.: US 2008/0113150 A1
(43) Pub. Date: May 15, 2008

(54) Suction tape

(76) Inventor: Calvin Chunliang Lee, Novi, MI (US)

Correspondence Address: Calvin Lee, 24294 Lynwood Dr., Novi, MI, 48374, US

(21) Appl. No.: 11/598,280

(22) Filed: Nov. 13, 2006

(51) Int. Cl. B32B 3/06

(52) U.S. Cl. 428/99

(57) ABSTRACT

A suction tape with a large number of miniature vacuum suction cups on one side or both sides is invented here. The suction tapes have many of the advantages of the double-sided adhesive tapes, hook-and-loop (Velcro) tapes, and vacuum suction cups without their disadvantages.

### BACKGROUND

1. Field of the Invention

This invention covers a reusable attachment device that can be used to attach two objects together and then cleanly removed and reused many times without deterioration of its attachment capacity.

2. Description of Prior Art

There are many commercially available reusable attachment devices in the marketplace. Examples are screws or nails to fasten a trim molding to a drywall, a double-sided adhesive tape to hold a photograph to a wall, repositionable adhesive to secure a logo to the exterior surface of a car, a vacuum suction cup with a hook to attach a sign to a window glass, and a pair of hook-and-loop (also being marketed under the Velcro trademark) tapes to bind two work pieces together, etc.

Reusable attachment devices such as screws and nails use mechanical frictional force to fasten two objects together. These attachment devices, also called mechanical fasteners, provide very good attachment capacity and are usually removable and reusable for many times. The major disadvantages of these mechanical fasteners are the objects to be fastened together must have fastener holes for these mechanical fasteners to pass through and the heads of the mechanical fasteners are usually visually exposed after installation.

Reusable attachment devices like repositionable adhesive and repositionable adhesive tapes use chemical bonding force to attach two objects. These chemical attachment devices work on uneven and mildly porous surfaces and they don't cause permanent damage (e.g. fastener holes) to the objects. The repositionable adhesive tapes, such as described in U.S. Pat. No. 5,516,581 and the readily available 3M's Removable Repositionable Tape 9415PC, 9425, 9416, 665, and 666, and repositionable adhesive such as the 3M's 72, 77, ReMount, and Spray Mount Repositionable Spray Adhesive are especially easy to use and store. The major disadvantages of these chemical attachment devices are the attachment strength of the adhesives is usually compromised for easy removal, the reusability is usually not as good as the mechanical fasteners, and the surfaces of the objects need to be clean, dry, and flat.

Reusable attachment devices like the hook-and-loop tapes, such as described in U.S. Pat. No. 3,009,235 by inventor George de Mestral, use a combination of mechanical and chemical bonding forces to attach two objects together. A hook-and-loop tape, which is also known as Velcro tape, is actually a pair of tapes with one tape having miniature hooks on one side and the other tape having matching miniature loops on one side. Both tapes have adhesive on the backing sides to install to the objects before the hook and loop sides are attached.

The Velcro tapes can be reused many times, are very easy to use and store, and they don't leave permanent marks like fastener holes in the objects. However, the major disadvantages of this hook-and-loop tapes are the need of a pair of matching tapes that cost more, the hook and loop tapes stay on the objects after they are separated, slack engagement between the hooks and loops that also leave relatively large gaps between the attached objects, the requirement of clean, dry, and flat surfaces of the two objects for the adhesive on the backing of the tapes to adhere to, and fabric fiber, hair, dust, and other foreign matters can easily get stuck in the loops and hooks and are difficult to be cleaned out.

Reusable attachment devices like vacuum suction cups, such as described in U.S. Pat. Nos. 6,648,285, 6,143,391, and 5,176,346, use pneumatic force to bind two objects together. One application is a vacuum suction cup with a hook, as described in U.S. Pat. Nos. 957,804 and 6,749,165, that attaches a sign to a window glass or ceramic tiled wall. A different application is an anti-slip soft plastic or rubber mat with molded-in suction cups on the bottom that secures the mat to the floor in a shower or the bottom of a bathtub, as described in U.S. Pat. No. 6,946,183. Another application is a double-sided suction made by joining two vacuum suction cups 11 end-to-end, as described in U.S. Pat. No. 6,375,143, that attaches two objects together.

Vacuum suction cups have good attachment capacity, can be used on wet surfaces, and are very reusable. The major disadvantages are the suction attachment area of the object needs to be flat, clean, smooth, non-porous, non-gas-permeable, and relatively rigid for an airtight sealing surface.

An application using the combination of vacuum suction cup and adhesive is described in U.S. Pat No. 5,047,102 for covering a porous wall with a non-porous patch with adhesive (e.g. an adhesive tape) on the backing before attaching the suction cup to the patch. The obvious disadvantages are the need of both a patch and a suction cup and the patch may not be cleanly removable and reusable. A suction cup described in U.S. Pat No. 4,421,288 has a flat central portion with a pressure-sensitive adhesive on the suction cup's concave side to assist the attachment. However, the adhesive will not work on wet surfaces and the reusability is also limited.

U.S. Pat No. 6,766,571 describes a thermoplastic polyester sheet having trapped air bubbles dispersed to create surface pores to provide suction effect when attached to a vehicle. This is a cost-effective reusable attachment device that can be used on many different applications. However, the irregularity of the shape, size, and location of these surface pores doesn't provide uniform and consistent attachment capacity. The construction of the polyester sheet having pores inside the sheet also requires the sheet to be compressed significantly, which may require significant effort, before the pores are compressed to form suction.

### OBJECTS AND ADVANTAGES

The suction tapes are convenient to use and store and can be used on uneven and mildly porous surfaces, sharing the advantages of the adhesive tapes and hook-and-loop tapes. They can also be used on wet and slippery surfaces like the vacuum suction cups. The suction tapes have good attachment capacity and are very removable and reusable for many times like the vacuum suction cups and hook-and-loop (Velcro) tapes.

The suction tapes have one-piece construction that provides very tight and stiff attachment, thus avoiding the major disadvantages of the hook-and-loop tapes such as the slack engagement between the hooks and loops and the need of a pair of matching hooks and loops tapes for each attachment. The suction tapes can be cleanly removed from an object, not like the hook-and-loop tapes which stay on the objects after separation. They don't trap fabric fiber, hair, dust, and other foreign matters, just opposite to the hook-and-loop tapes. The suction tapes can also be used on uneven and mildly porous surfaces that the vacuum suction cups usually don't accommodate because each of the miniature suction cups needs just a small flat and non-porous area to form an air-tight sealing and the large number of miniature suction cups will provide enough pneumatic attachment force even some of the suction cups don't find good surface areas to suck on.

### SUMMARY OF THE INVENTION

This invention is a suction tape which is a tape with an array of a large number of miniature vacuum suction cups to suck on objects. One preferred embodiment of this invention is to have the miniature vacuum suction cups on one side of the tape while having adhesive on the other side. This combination of a large number of miniature vacuum suction cups and adhesive tapes provides great attachment capacity, good reusability, ease of use, wide range of applications, and low cost of manufacturing.

Another preferred embodiment of the suction tape is to have the miniature vacuum suction cups on both sides of the tape so no adhesive is needed. It can be used for applications with both objects having wet, uneven, mildly porous, and relatively flexible or soft surfaces.

### BRIEF DESCRIPTION OF DRAWING FIGURES

FIG. 1 shows a suction tape 13 comprising of a flexible base tape 14 with a large number of miniature vacuum suction cups 15 on one side and adhesive 16 on the back side.

FIG. 2 shows a suction tape 13 with a large number of miniature vacuum suction cups 15 attaches to an object with mild porosity 17 on its surface.

FIG. 3 shows the cross-sectional view of two objects 20 and 21 attached together by a suction tape 13.

FIG. 4 shows two objects 22 and 23 of irregular shapes that are attached by a suction tape 13.

FIG. 5 shows the cross-sectional view of a double-sided suction tape 24 comprising of a flexible base tape 14 with a large number of miniature vacuum suction cups 15 on both sides.

FIG. 6 shows two objects 25 and 26 attached together with a double-sided suction tape 24.

FIG. 7 shows two suction tapes with different miniature suction cup geometries 27 and 28.

### REFERENCE NUMERALS IN DRAWINGS

13. Suction tape with adhesive backing

14. Flexible base tape

15. Miniature vacuum suction cups

16. Adhesive

17. Object with mild porosity on surface

18. Flat and void-free areas

19. Voids and holes

20. Object to be attached

21. Object to be attached

22. Object of irregular shape

23. Object of irregular shape

24. Double-sided suction tape

25. Object to be attached

26. Object to be attached

27. A honeycomb-shaped miniature vacuum suction cup

28. A bellows-shaped miniature vacuum suction cup

30. Miniature vacuum suction cups that cover voids and holes

31. Miniature vacuum suction cups that cover flat and non-porous areas

### DETAILED DESCRIPTION OF THE PREFERRED EMBODIMENTS

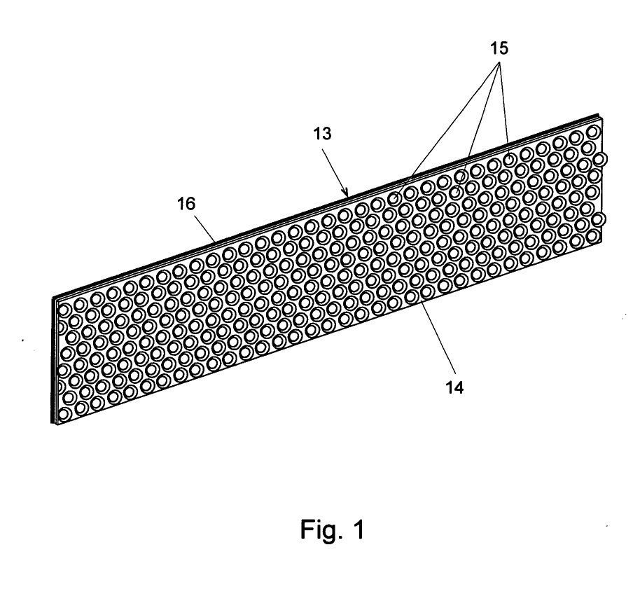

The first preferred embodiment of this invention 13 is shown in FIG. 1. It consists of a flexible base tape 14, a large number of miniature vacuum suction cups 15 on one side of the tape, and a layer of adhesive 16 on the other side.

The flexible base tape 14 is made of thin flexible materials such as flexible plastic, silicone rubber, or even thin ductile metal film stock of copper, titanium, or low carbon steel. The miniature vacuum suction cups 15 are made of non-gas-permeable elastic material such as silicone rubber, soft vinyl, or thin ductile metal film stock of copper, titanium, or low carbon steel. The adhesive 16 can be strong, permanent structural adhesive or repositionable adhesive for different applications.

The miniature vacuum suction cups 15 and the flexible base tape 14 can be manufactured as one integral piece with injection or blown molded elastic plastic materials such as silicone rubber or vinyl. They can also be assembled from separate flexible base tape 14 and miniature vacuum suction cups 15, made of flexible materials such as elastic plastic or ductile thin metal foil stock via various attachment means such as adhesive or spot welding.

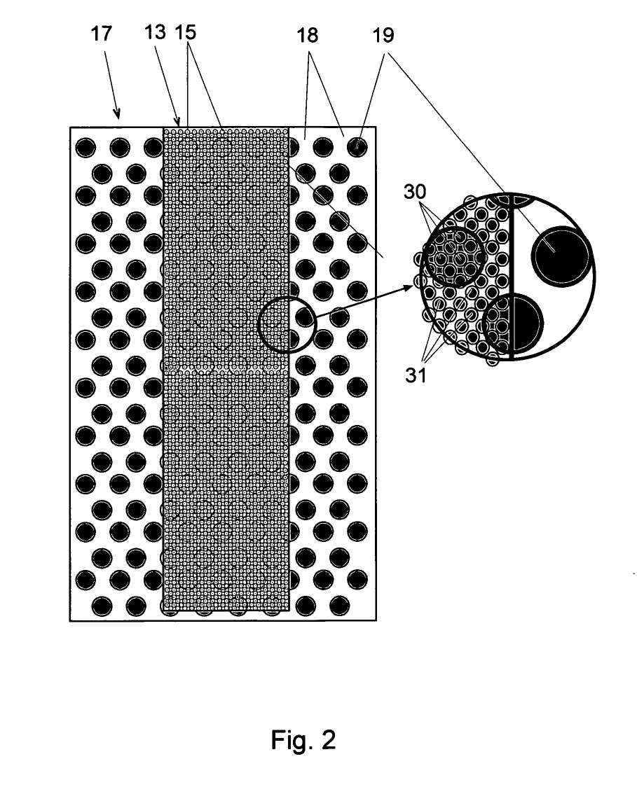

FIG. 2 shows a suction tape 13 attaches to an object with mild porosity 17. Each miniature suction cup needs only a small flat and non-porous area 18 to establish an airtight attachment. It is likely many of the vacuum suction cups 30 may cover the areas with voids and holes 19 and therefore do not attach well to the object 17. However, since there are a large number of miniature suction cups 15 present, it is very probable there will still be significant number of miniature suction cups 31 covering the flat and non-porous areas 18 of the surface that retain a good attachment to the object 17.

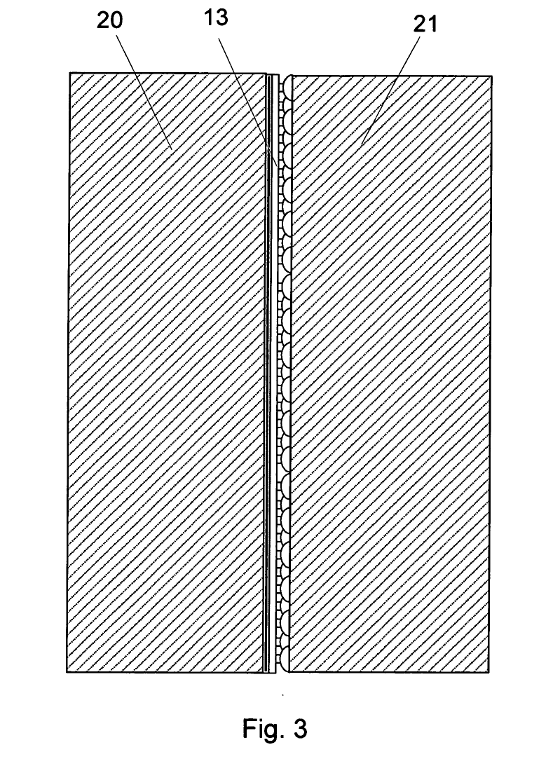

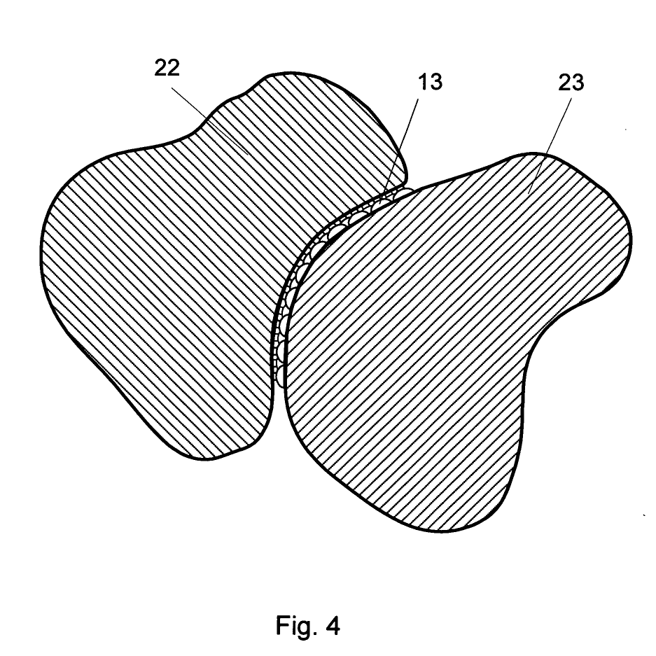

FIG. 3 shows the cross-sectional view of two objects 20 and 21 attached together via a suction tape 13 of the first preferred embodiment. FIG. 4 shows two objects 22 and 23 of irregular shapes that are attached together by a suction tape 13.

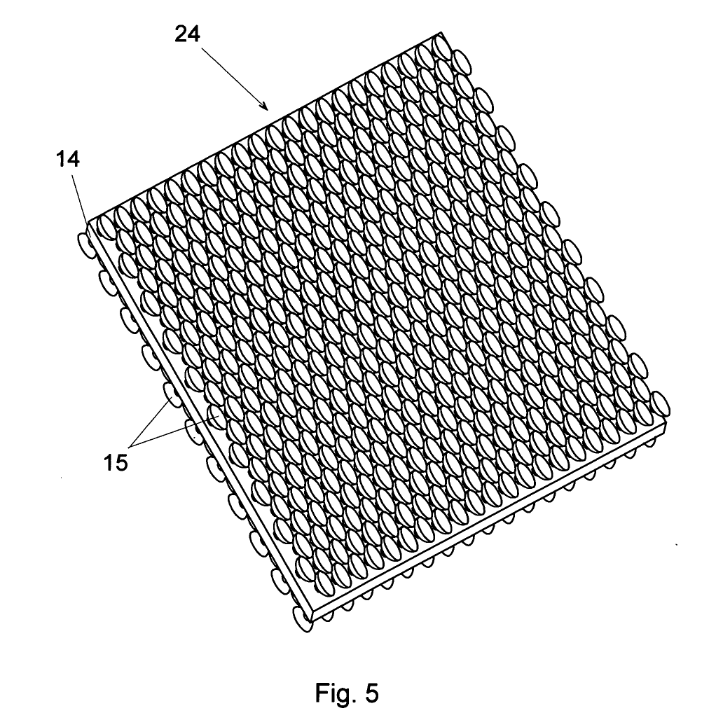

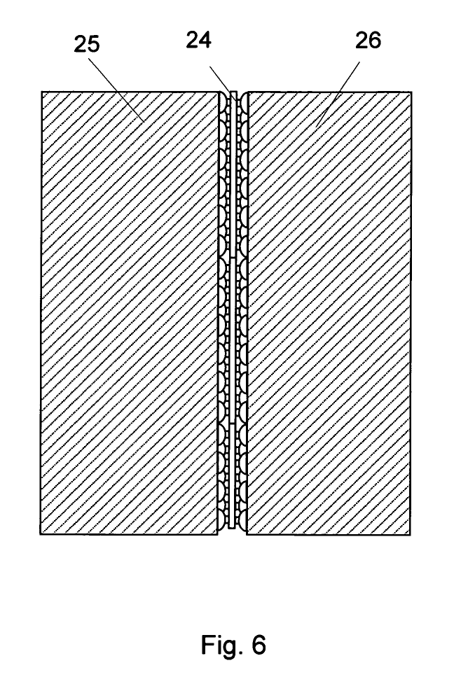

The second preferred embodiment of this invention is shown in FIG. 5. It is similar to the first preferred embodiment except the miniature vacuum suction cups 15 are installed on both sides of the flexible base tape 14 to make a double-sided suction tape 24. A cross-sectional view of two objects 25 and 26 attached together via a double-sided suction tape 24 of this preferred embodiment is shown in FIG. 6. This preferred embodiment can be used for applications with both objects having wet surfaces or need to be removed and reused many times without loosing good attachment capacity that the repositionable adhesive does not provide.

### CONCLUSION, RAMIFICATIONS, AND SCOPE

Thus the reader will see that the suction tape of the invention provides a reusable attachment method that possesses the advantages of the adhesive tapes, hook-and-loop tapes, and vacuum suction cups.

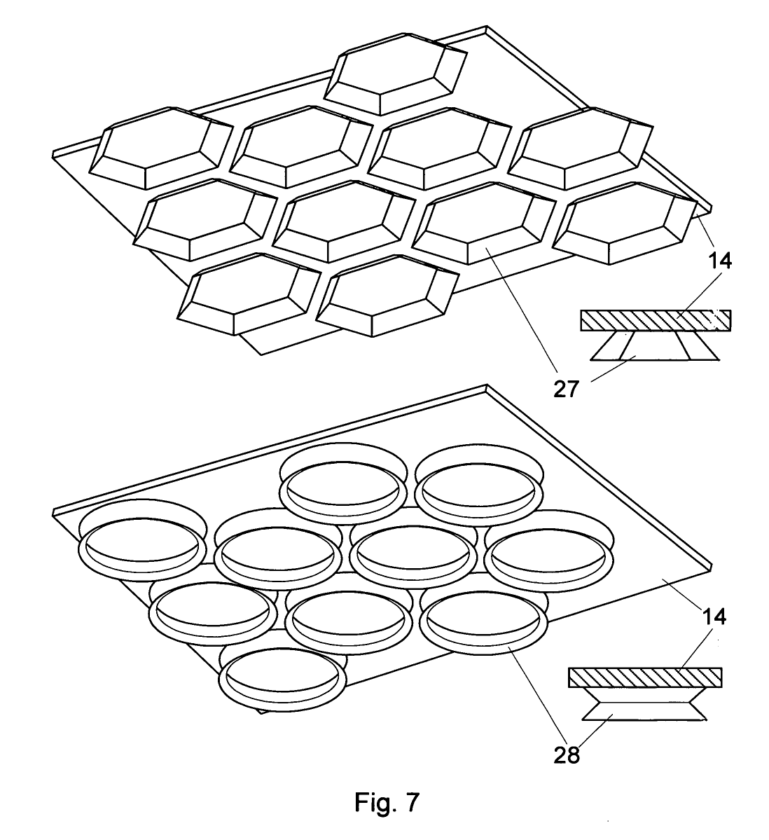

While my above description contains many specificities, these should not be construed as limitations on the scope of the invention, but rather as an exemplification of some preferred embodiments thereof. Many other variations are possible. For example, the miniature vacuum suction cups may be in other geometric shapes for different applications. FIG. 7 shows the suction tapes with suction cups of honeycomb-shape 27 and bellows-shape 28 that have different patterns of the arrays of suction cups and attachment stiffness and capacities.

I claim:

1. A suction tape comprising:
a. A flexible tape means,
b. A plural of miniature vacuum suction cups made of non-gas-permeable elastic material are installed with bottom ends onto one side of said flexible tape means, and
c. Adhesive means on the other side of said flexible tape means,
whereby said flexible tape means provides an underpinning of said miniature vacuum suction cups and said adhesive means.

2. A double-sided suction tape comprising:
a. A flexible tape means and
b. A plural of miniature vacuum suction cups made of non-gas-permeable elastic material with bottom ends installed onto both sides of said flexible tape means,
whereby said flexible tape means provides an underpinning of said miniature vacuum suction cups.
